(19) United States
(12) Patent Application Publication
(10) Pub. No.: US 2026/0021564 A1
(43) Pub. Date: Jan. 22, 2026

(54) TOOL FOR ADJUSTING AND HOLDING A CHAIN ON A SPROCKET

(71) Applicant: Airbus Operations SAS, TOULOUSE (FR)

(72) Inventor: Damien FRAYSSE, TOULOUSE (FR)

(21) Appl. No.: 19/260,995

(22) Filed: Jul. 7, 2025

(30) Foreign Application Priority Data
Jul. 17, 2024 (FR) FR2407828

(51) Int. Cl. B25B 27/22

(52) U.S. Cl. CPC B25B 27/22

(57) ABSTRACT

A tool for adjusting and holding a chain with links engaging with a sprocket, the tool has a shoe intended to be mounted in a fixed manner with respect to the sprocket, and a finger secured to the shoe and intended to be inserted into a link. Also, an assembly with such a tool.

### CROSS-REFERENCES TO RELATED APPLICATIONS

This application claims the benefit of French Patent Application Number FR2407828 filed on Jul. 17, 2024, the entire disclosure of which is incorporated herein by way of reference.

### FIELD OF THE INVENTION

The invention relates to a tool for adjusting the position of a chain on a sprocket and for holding it in this position during the phases of assembling the sprocket and the chain. The invention also relates to an assembly comprising such a tool with a sprocket and a chain.

### BACKGROUND OF THE INVENTION

FIG. 1 shows an aircraft 10 which conventionally comprises an elevator 12 that is moved by the pilot from the cockpit 14 as a function of the phases of flight of the aircraft 10. Such an elevator 12 is mounted so as to be able to rotate about an axis transverse to the aircraft 10.

Conventionally, the aircraft 10 comprises a control system 20 which allows the pilot to control the orientation of the elevator 12. FIG. 2 shows a control system 20 including a rotating control wheel 22 that is manipulated by the pilot as required. The control system 20 also comprises a sprocket 24 mounted on a shaft 25, which is mounted so as to be able to rotate, and a chain portion 26 that engages with the sprocket 24. The control system 20 also comprises a transmission system 28 which is between the control wheel 22 and the sprocket 24 and which is designed to transmit the movements of the control wheel 22 to the sprocket 24.

The control system 20 also comprises a pulley 30, mounted so as to be able to rotate, and a cable portion 32 which engages with the pulley 30. The chain portion 26 and the cable portion 32 are fixed to one another by means of tensioners 34 so as to form a loop. This cable portion 32 runs along the aircraft 10 to reach the rear of the aircraft 10 where the elevator 12 is arranged. This cable portion 32 passes through frames 29 (reinforcement or structural frames) along the entire length of the aircraft 10.

Another sprocket/pulley 34 is mounted so as to be secured to the elevator 12 and another chain/cable 36 is mounted between the pulley 30 and the other sprocket/pulley 34.

The movements of the control wheel 22 are transmitted to the elevator 12 in this way.

During the assembly of the aircraft 10, the chain portion 26 and the sprocket 24 are not necessarily assembled at the same time as the other elements and it is possible that the chain portion 26 will move on the sprocket 24. However, the position of the chain portion 26 with respect to the sprocket 24 must always be the same so that the settings of the control system 20 are optimal when the cable portion 32 and the rest of the control system 30 are installed.

### SUMMARY OF THE INVENTION

An object of the present invention is to provide a tool that makes it possible to adjust the chain portion and to hold it in position with respect to the sprocket.

To this end, a tool is proposed for adjusting and holding a chain with links engaging with a sprocket, said tool comprising:
a shoe intended to be mounted in a fixed manner with respect to the sprocket, and
a finger secured to the shoe and intended to be inserted into a link.

With such an arrangement, the chain is adjusted in position and held in this position.

Advantageously, the finger is fixed to the shoe by means of a bar for supporting a plurality of links arranged between the finger and the sprocket.

Advantageously, the shoe takes the form of a split cylinder to be fitted onto a shaft secured to the sprocket and comprising clamping means.

Advantageously, the tool comprises a non-slip ring intended to be mounted between the shoe and the shaft secured to the sprocket.

The invention also provides an assembly comprising a sprocket, a chain with links engaging with the sprocket and a tool according to one of the variants above, wherein the shoe is mounted in a fixed manner with respect to the sprocket, and wherein the finger is inserted into a link.

### BRIEF DESCRIPTION OF THE DRAWINGS

The features of the invention that are mentioned above, and others, will become more clearly apparent from reading the following description of at least one exemplary embodiment, said description being given in relation to the appended drawings, in which:

FIG. 1 is a view from above of an aircraft,

FIG. 2 is a schematic depiction of a control system,

FIG. 3 is a side view of an assembly according to the invention and comprising the tool according to the invention, and

FIG. 4 is a view from above of the assembly from FIG. 2.

### DETAILED DESCRIPTION OF THE PREFERRED EMBODIMENTS

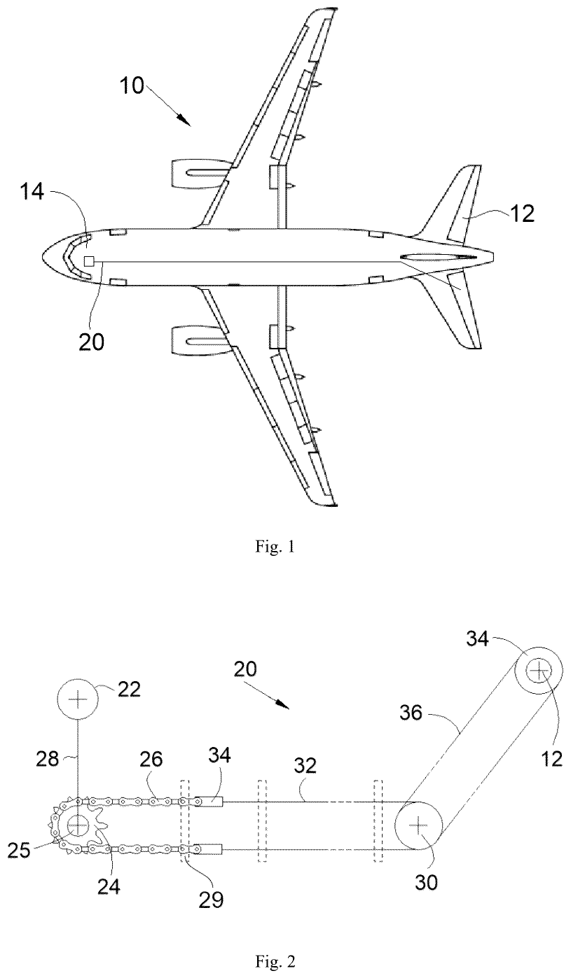

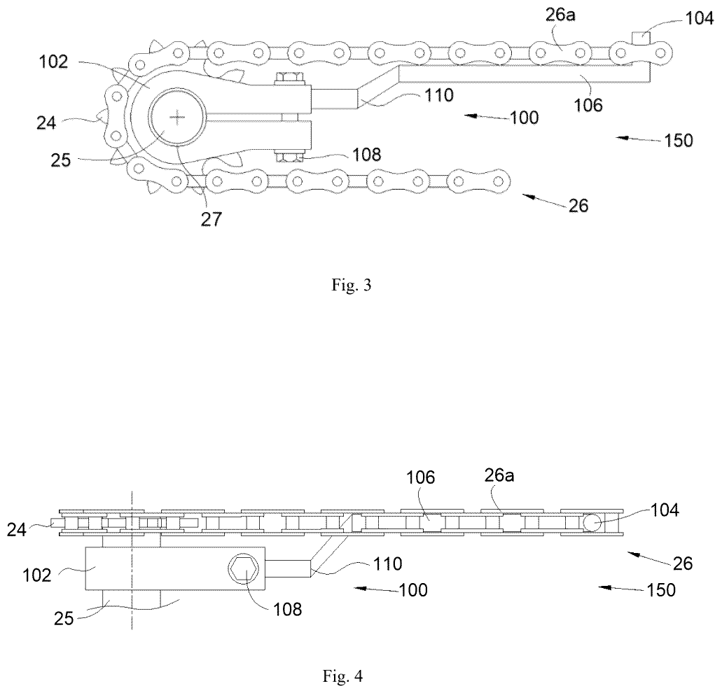

FIG. 1 shows an aircraft 10 on which the tool of the present invention may be used. In the same vein, FIG. 2 shows a control system 20 on which the tool of the present invention may be used. This tool is shown in FIGS. 3 and 4.

FIGS. 3 and 4 show an assembly 150 comprising a sprocket 24 and a chain 26 with links 26a, wherein the links 26a engage with the sprocket 24. This arrangement reproduces the elements of the control system 20 described above.

The sprocket 24 is secured to a shaft 25 mounted so as to be able to rotate about its axis.

The assembly 150 also comprises a tool 100 which adjusts the position of the chain 26 on the sprocket 24 and holds the chain 26 in position on the sprocket 24.

The tool 100 comprises a shoe 102 which is mounted in a fixed manner with respect to the sprocket 24, i.e., there is no relative movement between them.

The tool 100 also comprises a finger 104 which is secured to the shoe 102 and is inserted into a link 26a.

Since the finger 104 is in a particular position and is fixed with respect to the shoe 102, it is always inserted into the link 26a that is at a particular distance from the sprocket 24. Thus, by fixing the position of the finger 104 at a particular distance, it will be automatically inserted into the last link 26a of the chain 26.

In general, by fixing the tool 100, the finger 104 is always placed in the same link 26a, thus ensuring the adjustment of the chain 26 with respect to the sprocket 24 which in turn fixes the chain in position, since the chain 26 is locked and the sprocket 24 therefore cannot rotate.

The assembly 150 can then be transported and handled without any risk of misadjustment. Once the assembly 150 is mounted and fixed in its final environment, for example in the control system 20, the tool 100 is removed.

In order to allow removal of the tool 100, the shoe 102 is fixed in a detachable manner.

In order to support the chain 26 as well as possible between the sprocket 24 and the finger 104, the latter is fixed to the shoe 102 by means of a bar 106, which is arranged to be placed under the chain 26 between the sprocket 24 and the finger 104. Thus, the bar 106 supports a plurality of links 26a which are arranged between the finger 104 and the sprocket 24.

As can be better seen in FIG. 4, the shoe 102 is arranged beside the sprocket 24 (i.e., in a plane parallel to the plane of the sprocket 24), while the bar 106 and the finger 104 are arranged under the chain 26 and in the plane of the sprocket 24. The bar 106 is thus fixed to the shoe 102 by means of an elbow 110.

In the embodiment of the invention presented here, the shoe 102 takes the form of a split cylinder which is fitted onto the shaft 25 and it has clamping means 108, such as fastener and a nut, so as to clamp the split cylinder against the shaft 25.

When the shoe 102 is fitted onto the shaft 25, a non-slip ring 27 (visible in FIG. 3) can be added between the shoe 102 and the shaft 25, so as to improve holding of the tool 100 on the shaft 25 and to prevent damage to the sprocket 24. In other words, the tool 100 comprises a non-slip ring 27 intended to be mounted between the shoe 102, and more precisely an inner part of the cylinder forming the shoe 102, and the shaft 25.

Of course, it is possible to provide a different fixing for the shoe 102, such as, for example, a fixing by means of screwing, clipping, etc., directly to a side of the sprocket 24. The shoe 102 can also be fixed at a distance from the sprocket 24, and close to the finger 104, depending on the space available for fixing the tool 100, as well as for the manipulation thereof. For example, the tool 100 may be fixed not to the shaft 25 but to a frame 29 of the aircraft 10 through which the chain 26 passes.

During subsequent maintenance operations, the tool 100 can be repositioned so as to hold the chain 26.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A tool for adjusting and holding a chain with links engaging with a sprocket, said tool comprising:
a shoe configured to be mounted in a fixed manner with respect to the sprocket, the shoe comprising a split cylinder to be fitted onto a shaft secured to the sprocket and further comprising clamping means; and
a finger secured to the shoe and configured to be inserted into a link of the chain.

2. The tool according to claim 1, wherein the finger is fixed to the shoe by a bar configured to support a plurality of links arranged between the finger and the sprocket.

3. The tool according to claim 1, further comprising:
a non-slip ring configured to be mounted between the shoe and the shaft secured to the sprocket.

4. An assembly comprising:
a sprocket;
a chain with links engaging with the sprocket; and
the tool according to claim 1, wherein the shoe is mounted in a fixed manner with respect to the sprocket, and
wherein the finger is inserted into a link.

5. The assembly according to claim 4, wherein the finger is fixed to the shoe by a bar supporting a plurality of links arranged between the finger and the sprocket.

6. The assembly according to claim 4, wherein the tool further comprises a non-slip ring mounted between the shoe and the shaft secured to the sprocket.
